(19) United States
(12) Patent Application Publication
(10) Pub. No.: US 2026/0212209 A1
(43) Pub. Date: Jul. 23, 2026

(54) HYBRID PIPELINE SCHEDULING METHOD FOR DISTRIBUTED DEEP LEARNING TRAINING, ELECTRONIC DEVICE AND STORAGE MEDIUM

(71) Applicant: Beijing Baidu Netcom Science Technology Co Ltd., Beijing (CN)

(72) Inventors: Yuqin Zhang, Beijing (CN); Yanjun Ma, Beijing (CN); Dianhai yu, Beijing (CN); Liang Shen, Beijing (CN)

(21) Appl. No.: 19/568,049

(22) Filed: Mar. 16, 2026

(30) Foreign Application Priority Data
Jun. 13, 2025 (CN) 202510795873.4

(51) Int. Cl. G06N 3/098

(52) U.S. Cl. CPC G06N 3/098

(57) ABSTRACT

Provided is a hybrid pipeline scheduling method for distributed deep learning training, an electronic device and a storage medium, relating to the technical field of artificial intelligence, and particularly to the technical field of distributed training, machine learning and deep training. The method includes: dividing training data into N consecutive chunks, wherein each chunk includes K micro-batches; performing calculations on first N−1 chunks by using an interleaved forward-then-backward scheduling strategy; and performing calculations on an N-th chunk by using an interleaved 1F1B scheduling strategy. Among them, the performing calculations on the N-th chunk by using the interleaved 1F1B scheduling strategy includes: for any micro-batch in the N-th chunk, triggering a backward calculation immediately upon completion of its forward calculation; and for any micro-batch, releasing a video memory occupied by an activation value generated during its forward calculation immediately upon completion of its backward calculation.

### CROSS-REFERENCE TO RELATED APPLICATIONS

The present application claims priority to Chinese Patent Application No. CN202510795873.4, filed with the China National Intellectual Property Administration on Jun. 13, 2025, the disclosure of which is hereby incorporated herein by reference in its entirety.

### TECHNICAL FIELD

The present disclosure relates to the technical field of artificial intelligence, and particularly to the technical field of distributed training, machine learning and deep training.

### BACKGROUND

Pipeline parallelism is a commonly used distributed strategy partitioning a model onto different computing devices by layers. In order to reduce a bubble rate, a batch is partitioned into a plurality of micro-batches. In some pipeline scheduling algorithms, backward calculations cannot commence until all forward calculations have been completed. However, after each forward calculation, its activation values are saved in a video memory for use in subsequent backward calculations. A large number of micro-batches in a pipeline leads to high video memory consumption and consequently high peak video memory usage throughout a pipeline process. High video memory overhead may result in an out of memory (OOM) error on the device, rendering the model untrainable.

### SUMMARY

The present disclosure provides a hybrid pipeline scheduling method and apparatus for distributed deep learning training.

According to a first aspect of the present disclosure, provided is a hybrid pipeline scheduling method for distributed deep learning training, which is applied in a pipeline parallel architecture including a plurality of computing devices, the method includes:
dividing training data into N consecutive chunks, wherein each chunk includes K micro-batches, wherein N≥2, K≥2 and both N and K are integers;
performing calculations on first N−1 chunks by using an interleaved forward-then-backward (Interleaved-FthenB) scheduling strategy; and
performing calculations on an N-th chunk by using an interleaved 1F1B scheduling strategy,
wherein the performing calculations on an N-th chunk by using an interleaved 1F1B scheduling strategy includes: for any micro-batch in the N-th chunk, triggering a backward calculation immediately upon completion of its forward calculation; and for any micro-batch, releasing a video memory occupied by an activation value generated during its forward calculation immediately upon completion of its backward calculation.

According to a second aspect of the present disclosure, provided is a hybrid pipeline scheduling apparatus for distributed deep learning training, which is applied in a pipeline parallel architecture including a plurality of computing devices. The apparatus includes a dividing module configured to divide training data into N consecutive chunks, wherein each chunk includes K micro-batches, wherein N≥2, K≥2 and both N and K are integers; a first scheduling module configured to perform calculations on first N−1 chunks by using an interleaved forward-then-backward scheduling strategy; and a second scheduling module configured to perform calculations on an N-th chunk by using an interleaved 1F1B scheduling strategy, wherein the second scheduling module includes a first control submodule configured to: for any micro-batch in the N-th chunk, trigger a backward calculation immediately upon completion of its forward calculation; and a second control sub-module configured to: for any micro-batch, release a video memory occupied by an activation value generated during its forward calculation immediately upon completion of its backward calculation.

According to a third aspect of the present disclosure, provided is an electronic device including:
at least one processor; and
a memory communicatively connected to the at least one processor, wherein
the memory stores an instruction executable by the at least one processor, and the instruction is executed by the at least one processor to cause the at least one processor to perform the hybrid pipeline scheduling method for distributed deep learning training.

According to a fourth aspect of the present disclosure, provided is a non-transitory computer-readable storage medium storing a computer instruction, wherein the computer instruction is used to cause a computer to perform the hybrid pipeline scheduling method for distributed deep learning training.

According to a fifth aspect of the present disclosure, provided is a computer program product including a computer program stored on a storage medium, wherein the computer program, when executed by a processor, implements the hybrid pipeline scheduling method for distributed deep learning training.

According to a solution of the present disclosure, by replacing a scheduling strategy of a last chunk in the pipeline with the 1F1B scheduling strategy capable of immediately releasing activation values, a peak video memory usage in a training process is effectively reduced. In this way, the peak video memory usage during pipeline parallel training of a deep learning model can be reduced. As a result, video memory requirements during large model training are significantly decreased, and the training efficiency is increased.

The above summary is presented for the purpose of this specification only and is not intended to be limiting in any way. In addition to illustrative aspects, embodiments and features described above, further aspects, embodiments and features of the present application will be readily apparent by reference to accompanying drawings and the following detailed description.

### BRIEF DESCRIPTION OF THE DRAWINGS

In accompanying drawings, same or similar reference numerals indicate same or similar components or elements throughout several accompanying drawings, unless otherwise specified. These accompanying drawings are not necessarily drawn to scale. It should be understood that these accompanying drawings depict only some embodiments disclosed in the present application and should not be considered as limiting a scope of the present application.

FIG. 1 is a schematic diagram of an Interleaved-FthenB scheduling method in the related art;

FIG. 2 is a schematic diagram of a hybrid pipeline scheduling method according to an embodiment of the present disclosure;

FIG. 3 is a schematic flowchart of a hybrid pipeline scheduling method for distributed deep learning training according to an embodiment of the present disclosure;

FIG. 4 is a schematic structural diagram of a hybrid pipeline scheduling apparatus for distributed deep learning training according to an embodiment of the present disclosure;

FIG. 5 is a schematic diagram of a scenario of a hybrid pipeline scheduling method for distributed deep learning training according to an embodiment of the present disclosure; and

FIG. 6 is a schematic structural diagram of an electronic device of a hybrid pipeline scheduling method for distributed deep learning training according to an embodiment of the present disclosure.

### DETAILED DESCRIPTION

Exemplary embodiments of the present disclosure will be described below with reference to accompanying drawings, wherein various details of embodiments of the present disclosure are included to facilitate understanding, and should be considered as merely exemplary. Therefore, those ordinarily skilled in the art should realize that various changes and modifications can be made to embodiments described herein without departing from the scope of the present disclosure. Likewise, for clarity and conciseness, descriptions of well-known functions and structures are omitted in the following description.

Terms “first”, “second”, “third” or the like used in embodiments, claims and accompanying drawings of the detailed description of the present disclosure are intended to distinguish similar objects and are not necessarily used to describe a specific order or sequence. Furthermore, terms “comprising”, “including” and “having” as well as any variations thereof are intended to cover non-exclusive inclusions, such as encompassing a series of steps or units. Methods, systems, products or devices are not necessarily limited to steps or units explicitly listed, but may include further steps or units that are not explicitly listed or inherent to such processes, methods, products or devices.

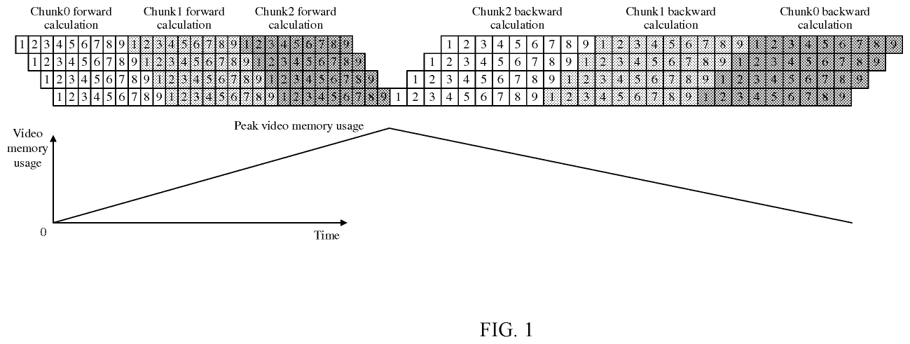

With an increasing scale of a deep learning model, distributed training across computing devices has become indispensable. Nevertheless, existing pipeline parallel solutions exhibit low video memory utilization. FIG. 1 shows a schematic diagram of an interleaved-FthenB scheduling method in the related art. As shown in FIG. 1, for such an interleaved-FthenB scheduling method, in a forward calculation stage, a video memory occupancy of a pipeline gradually increases until a peak video memory usage of the pipeline is reached after a last micro-batch in a last chunk is completed. A large number of micro-batches in the pipeline leads to high peak video memory usage throughout a pipeline process, which may result in an out of memory (OOM) error on a device, rendering the model untrainable.

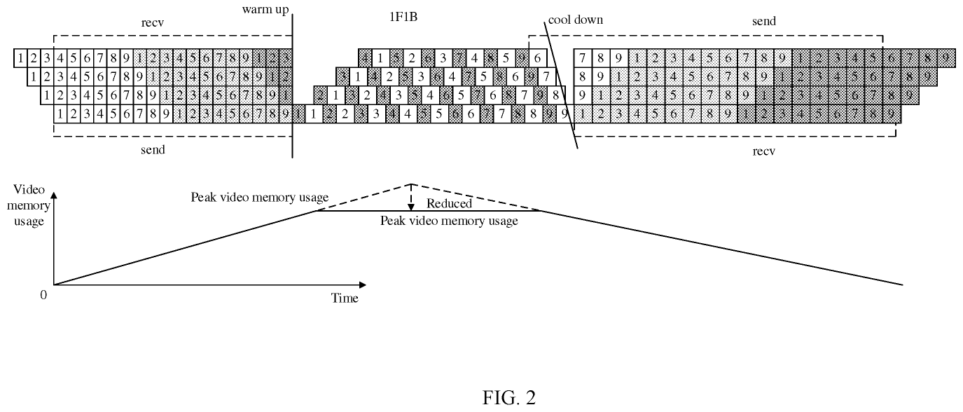

In order to at least partially solve the above problems and one or more of other potential problems, the present disclosure provides a hybrid pipeline scheduling method for distributed deep learning training. The last chunk adopting interleaved-FthenB scheduling is modified to interleaved 1F1B scheduling, such that the pipeline reaches the peak video memory usage upon completion of a first micro-batch in the last chunk. Compared with the peak video memory usage in the interleaved-FthenB, a number of micro-batches accumulated at the peak video memory usage is significantly reduced, thereby effectively lowering the peak video memory usage. FIG. 2 shows a schematic diagram of a hybrid pipeline scheduling method according to an embodiment of the present disclosure. As shown in FIG. 2, the last chunk adopting the interleaved-FthenB scheduling is modified to the interleaved 1F1B scheduling. Particularly, a backward calculation is performed immediately after each forward calculation of the last chunk is completed. Upon completion of the backward calculation, activation values used by the backward calculation are released immediately. Therefore, under the interleaved 1F1B scheduling, the peak video memory usage does not continue to increase. Accordingly, the pipeline reaches the peak video memory usage upon completion of the first micro-batch of the last chunk. Compared with the peak video memory usage in original interleaved-FthenB, the number of the micro-batches accumulated at the peak video memory usage in this solution is significantly reduced, thereby effectively lowering the peak video memory usage. Such a solution is mainly applied in large model training to reduce the peak video memory usage in a pipeline parallel layer when the interleaved-FthenB pipeline parallelism is employed.

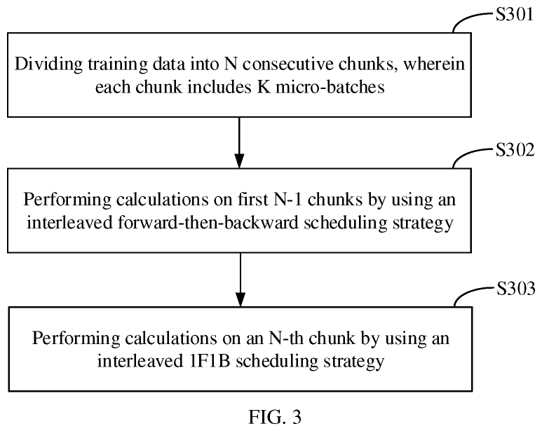

An embodiment of the present disclosure provides a hybrid pipeline scheduling method for distributed deep learning training, which is applied in a pipeline parallel architecture including a plurality of computing devices. FIG. 3 is a schematic flowchart of a hybrid pipeline scheduling method for distributed deep learning training according to an embodiment of the present disclosure. The hybrid pipeline scheduling method can be applied in a hybrid pipeline scheduling apparatus. The hybrid pipeline scheduling apparatus is located on a computing device within an electronic device. The electronic device includes but is not limited to a stationary device and/or a mobile device. For example, the stationary device includes but is not limited to a server, which may be a cloud server or a general-purpose server. For example, the mobile device includes but is not limited to a mobile phone, a tablet computer and the like. In some possible implementations, the hybrid pipeline scheduling method can be implemented in a manner of invoking a computer-readable instruction stored in a memory by a processor. The hybrid pipeline scheduling method is applied in a pipeline parallel architecture including a plurality of computing devices. As shown in FIG. 3, the hybrid pipeline scheduling method includes:
S301, dividing training data into N consecutive chunks, wherein each chunk includes K micro-batches, wherein N≥2, K≥2 and both N and K are integers;
S302, performing calculations on first N−1 chunks by using an interleaved forward-then-backward scheduling strategy; and
S303, performing calculations on an N-th chunk by using an interleaved 1F1B scheduling strategy,
wherein the performing calculations on an N-th chunk by using an interleaved 1F1B scheduling strategy includes: for any micro-batch in the N-th chunk, triggering a backward calculation immediately upon completion of its forward calculation; and for any micro-batch, releasing a video memory occupied by an activation value generated during its forward calculation immediately upon completion of its backward calculation.

In embodiments of the present disclosure, the chunk is a continuous data unit composed of a plurality of micro-batches, which serves as a basic processing unit for pipeline scheduling. Exemplarily, when a total number of the micro-batches is 64 and K=16, the micro-batches are divided into 4 chunks, i.e., N=4.

In embodiments of the present disclosure, the micro-batches are smaller data units obtained by subdividing a training batch, which are used in pipeline parallelism. Exemplarily, if batch_size=4096, a batch is divided into 64 micro-batches (each micro-batch includes 64 pieces of data).

In embodiments of the present disclosure, the interleaved forward-then-backward scheduling strategy is a strategy alternately performing continuous forward calculations and delayed backward calculations on a plurality of micro-batches within the same chunk. Exemplarily, for the 16 micro-batches within a chunk1, all 16 forward calculations are performed first, after which all 16 backward calculations are performed.

In embodiments of the present disclosure, the interleaved 1F1B scheduling is a strategy triggering a single backward calculation immediately upon completion of a single forward calculation for a micro-batch. Exemplarily, for a first micro-batch within a chunk4, a backward calculation is triggered immediately upon completion of a forward calculation, and this process repeats.

In embodiments of the present disclosure, an activation value video memory is a video memory space occupied by intermediate results generated during the forward calculation. Exemplarily, a tensor output from a transformer layer has a shape of [micro-batch, seq_len, hidden_dim], wherein micro_batch represents a number of samples processed during a single forward propagation, seq_len represents a token length of an input sequence, and hidden_dim represents a dimension of a feature vector of each token.

In some implementations, chunk division includes: inputting a training dataset, wherein a total number of the micro-batches is set to 64, and K is set to 16 (each chunk includes 16 micro-batches), such that a system automatically calculates N=64/16=4; and generating 4 consecutive chunks in a data order:
a chunk1: micro-batches 1-16,
a chunk2: micro-batches 17-32,
a chunk3: micro-batches 33-48, and
a chunk4: micro-batches 49-64.

In some implementations, the interleaved-FthenB scheduling for the first N−1 chunks (taking the chunk1 in a 4-stage pipeline as an example) includes:
a device 1: sequentially performs forward calculations on the micro-batches 1-16;
a device 2: receives an output of the device 1, and sequentially performs forward calculations on the micro-batches 1-16; and
a device 3/4: sequentially performs forward calculations similarly.
when all 16 micro-batches of the chunk1 are completed, the backward calculation is initiated in a reverse order of the micro-batches 16→1.

Note: the peak video memory usage at this stage occurs at a moment when the forward calculation for a last micro-batch of the chunk1 is completed (at which point 16 sets of activation values have been accumulated).

In some implementations, the interleaved-FthenB scheduling for the N-th chunk (taking the chunk4 in the 4-stage pipeline as an example) includes:
a device 1:
performs a forward calculation on the micro-batch 49, and triggers a backward calculation for the micro-batch 49 immediately upon completion of the forward calculation, and
performs a forward calculation for the micro-batch 50 and triggers a backward calculation for the micro-batch 50 immediately upon completion of the forward calculation (without waiting for subsequent micro-batches);
a device 2:
receives a forward result for the micro-batch 49, completes the forward calculation and immediately releases an activation value video memory for the micro-batch 49 in the device 1,
performs the backward calculation for the micro-batch 49, completes the backward calculation and releases activation values in this device; and
a device 3/4: similarly performs forward and backward calculations alternatively.

As such, when the backward calculation for the micro-batch 49 is completed, activation values of the micro-batch 49 are released from video memories of the devices 1-4.

Taking the 4-stage pipeline (S=4) and the device 2 (s=2) in the chunk4 as an example: a number of the micro-batches with unreleased activation values is less than or equal to 4−2+1=3 (compared with 16 in a traditional solution). The video memory occupancy is significantly reduced, allowing for a larger batch size (batch_size).

The solution in the present disclosure is also applicable to a mixture of experts (MoE) model, wherein each expert module serves as an independent pipeline stage.

The technical solution of embodiments of the present disclosure effectively reduces a peak video memory usage in a training process by replacing the scheduling strategy for the last chunk of the pipeline with the 1F1B scheduling strategy capable of immediately releasing the activation values.

Compared with the traditional pipeline scheduling method, the scheduling method described in the present disclosure significantly optimizes a video memory occupancy mechanism.

The traditional solution requires the accumulation of activation values of K micro-batches before releasing the video memory, whereas the scheduling method described in the present disclosure employs a dynamic release mechanism to limit the number of the micro-batches with the unreleased activation values to (S−s+1), thereby significantly reducing a peak video memory pressure.

With respect to pipeline efficiency, the traditional method exhibits a high bubble rate due to delayed backward calculations. The present disclosure achieves an order-of-magnitude decrease in the bubble rate through a collaborative mechanism triggering the backward calculations and releasing the video memory immediately. Such an optimization enables the system to support an order-of-magnitude increase in model scale, thereby transcending training capacity limits inherent in the traditional scheduling method.

In some embodiments, the interleaved 1F1B scheduling strategy enables a peak video memory usage to occur at a moment when the forward calculation for a first micro-batch in the N-th chunk is completed.

In embodiments of the present disclosure, the moment at which the peak video memory usage occurs is a time point when the occupancy of the video memory reaches its maximum value during pipeline parallel training.

In embodiments of the present disclosure, the interleaved 1F1B scheduling strategy is a strategy of performing “triggering a single backward calculation immediately upon completion of a single forward calculation” on the micro-batches in the N-th chunk. Exemplarily, the forward calculation for the micro-batch X is completed and the backward calculation for the micro-batch X is initiated immediately (without waiting for other micro-batches).

In embodiments of the present disclosure, the first micro-batch in the N-th chunk is an initial data unit in the last chunk. Exemplarily, when N=4, the first micro-batch refers to the micro-batch 49 in the chunk4.

In embodiments of the present disclosure, a forward calculation completion moment is defined as a timestamp at which a forward propagation for a certain micro-batch is completed in the last pipeline stage. Exemplarily, the forward calculation completion moment refers to time at which the device 4 outputs activation values of the last layer for the micro-batch 49.

In some embodiments, a mechanism for forming a peak video memory usage is implemented in a process including:
step 1, initializing scheduling for the N-th chunk:
a device 1 receives a first micro-batch (mb49) of a chunk4, and
devices 2-4 remain idle and are in a standby state (the occupancy of the video memory is at a baseline value);
step 2, showing a forward calculation propagation for the first micro-batch in Table 1:

TABLE 1

| | | | | | Video |
|---|---|---|---|---|---|
| | | | | | Memory |
| Time | Device 1: | Device 2: | Device 3: | Device 4: | Accumulation |
| t1 | performs the forward | — | — | — | 1 activation |
| | calculation on the | | | | value set |
| | mb49 (Layer1) | | | | |
| t2 | outputs the mb49 to | performs the | — | — | 2 activation |
| | the device 2 | forward | | | value sets |
| | | calculation on | | | |
| | | the mb49 | | | |
| | | (Layer2) | | | |
| t3 | processes the forward | outputs a result | performs the | — | 3 activation |
| | calculation for the | of performing | forward | | value sets |
| | mb50 | the forward | calculation on | | |
| | | calculation on | the mb49 | | |
| | | the mb49 to the | | | |
| | | device 3 | | | |
| t4 | . . . | processes the | outputs a | performs the | 4 activation |
| | | forward | result of | forward | value sets, |
| | | calculation for | performing | calculation on | reaching the |
| | | the mb50 | the forward | the mb49 | peak video |
| | | | calculation on | (Layer4) | memory |
| | | | the mb49 to | | usage |
| | | | the device 4 | | |

as can be seen from Table 1, at a moment time t4 (when the device 4 completes the forward calculation for the mb49):
the device 1 holds the activation values of the mb50 (Layer1 output),
the device 2 holds the activation values of the mb50 (Layer2 output),
the device 3 holds the activation values of the mb49 (Layer3 output),
the device 4 holds the activation values of the mb49 (Layer4 output),
reaching the peak video memory usage which is equal to S (a number of the devices) activation value sets; and
step 3, immediately performing the backward calculation to release the video memory, as shown in Table 2:

TABLE 2

| Time | Critical Event | Video Memory Variation |
|---|---|---|
| t4 + δ | the device 4 completes the | |
| | forward calculation for the | |
| | mb49 and initiates the | |
| | backward calculation for the | |
| | mb49 immediately | |
| t5 | the device 4 completes the | peak video memory usage, |
| | backward calculation for the | reaching 3 activation |
| | mb49 and releases activation | value sets |
| | values of the Layer4 | |
| t6 | the device 3 receives a | 2 activation value sets |
| | backward gradient and releases | |
| | activation values of the Layer3 | |

continuously releases the video memory until reaching a baseline

Compared with a traditional pipeline scheduling solution, the interleaved 1F1B scheduling strategy of the present disclosure achieves groundbreaking improvements in the following three aspects:

1. A moment at which the peak video memory usage occurs is significantly advanced.

In the traditional interleaved-FthenB scheduling, the peak video memory usage occurs at a moment when the forward calculation for the last micro-batch in the N-th chunk is completed.

In contrast, this solution employs an immediate backward mechanism to accurately control the peak video memory usage to occur at a moment when the forward calculation for the first micro-batch of the N-th chunk is completed. Such an optimization advances a video memory pressure release window by more than 87%, thereby substantially reducing a period of occupancy of the video memory.

A number of the activation values at the peak video memory usage is reduced by an order of magnitude.

The traditional solution requires the accumulation of the activation values of K micro-batches of (typically, K≥16), resulting in a linear increase in occupancy of the video memory. In contrast, this solution reduces the number of the unreleased activation values to the total number S (typically, S≤8) of the stages of the pipeline, reducing the occupancy of the peak video memory usage to an order of 1/K of that in the traditional solution. For example, when K=32 and S=8, video memory requirements are sharply reduced by 75%, breaking through the bottleneck of large model training.

3. A model training capacity is increased by an order of magnitude.

The traditional solution is forced to limit the number K of the micro-batches in order to control the peak video memory usage, which severely constraining a scale of the model. In contrast, this solution supports an increase in K by more than 10 times under the same hardware conditions, making it possible to train a model with tens of billions of parameters on a single GPU.

Taking large model training as an example, a maximum number of model parameters that can be supported in an 8-GPU A100 cluster is increased by a factor of several times, thereby providing a feasibility basis for a model with hundreds of billions of parameters.

The above technical effects have been demonstrated by experiments to be unpredictable:
temporal disruptiveness: the peak video memory usage is relocated from the end of the chunk to a beginning thereof, contradicting the traditional perception that “the video memory usage increases with the accumulation of calculations”;
nonlinear optimization: a magnitude (1/K) of reduction in the video memory is independent from the scale of the device, breaking through resource limitation laws inherent in distributed training.
industry contribution: training the model with hundreds of billions of parameters for the first time is implemented on a consumer-grade GPU cluster, solving the long-standing problem of a “memory wall”.

### Experimental Evidences

In a process of training a Bidirectional Encoder Representations from Transformers (BERT) model (with S=4, K=16), the measured peak video memory usage is described as follows:
the traditional solution: the peak video memory usage occurs at a moment when the calculation for a micro-batch 16 is completed, with 16 activation value sets (approximately 24 GB);
this solution: the peak video memory usage occurs at a moment when the calculation for a micro-batch 1 is completed, with 4 activation value sets (approximately 6 GB); and
a model convergence speed is increased by 2.3 times, confirming the significance of the technical effect.

In some embodiments, a number N of the chunks is equal to a pipeline depth.

In embodiments of the present disclosure, the pipeline depth is a number of stages into which the model is divided during distributed training, which is equal to a number of physical devices participating in pipeline parallelism. Exemplarily, the model is divided into 4 stages during training on a 4-GPU setup, with a depth equal to 4. The pipeline depth is equal to a number of physical devices participating in the calculation. Assuming that time required for the device to process a single micro-batch is t, when N=S, the total time T is given by T=(N+K−1)t; and when N≠S, T≥(N+S+K−2)t. This constraint greatly reduces the training cost of the model with hundreds of billions of parameters on a cluster with thousands of GPUs.

In embodiments of the present disclosure, the number N of the chunks is a total number of consecutive chunks into which training data is divided. Exemplarily, when the total number of the micro-batches is 64 and K=16, N=4.

In embodiments of the present disclosure, an equivalence relationship refers to a constraint that N is strictly equal to the pipeline depth (N−S). Exemplarily, if the pipeline depth S is equal to 4, the training data must be divided into N=4 chunks. A condition of N=S needs to be satisfied, and each pipeline stage (device) exclusively processes a chunk, which can maximize the utilization of device resources.

Taking the 4-stage pipeline as an example, implementation steps include:
step 1, determining the pipeline depth:
a number of available GPUs is detected as 4, accordingly, the pipeline depth S is equal to 4, and
the system automatically configures the number of the chunks such that N=S=4;
step 2, dynamically dividing the chunk:
input: a training dataset (such as WikiText-103), with a total of 64 micro-batches,
calculation of a size of each chunk: K is equal to the total number of the micro-batches divided by N, yielding K=64/4=16, and
generation of the chunks:
a chunk1: micro-batches 1-16,
a chunk2: micro-batches 17-32,
a chunk3: micro-batches 33-48, and
a chunk4: micro-batches 49-64;
step 3, binding a scheduling strategy for a device and a chunk:

TABLE 3

| Device | Binding Chunk | Scheduling Behavior |
|---|---|---|
| GPU1 | chunk1 | performs forward/backward calculations on all 16 |
| | | micro-batches |
| GPU2 | chunk2 | performs calculations on the micro-batches 17-32 |
| GPU3 | chunk3 | performs calculations on the micro-batches 33-48 |
| GPU4 | chunk4 | employs 1F1B scheduling (the backward calculation |
| | | is triggered immediately upon completion of the |
| | | forward calculation) |

When the GPU4 processes the first micro-batch in the chunk4, the GPU1 has begun to release the video memory of the chunk1.

During BERT training (with S=8, N=8, K=32), experimental measurements demonstrate that the idle time of the device is reduced from 19.7% in the traditional solution to 0.3%, the peak video memory usage is reduced from 48 GB to 22 GB, and the training throughput is increased by a factor of 2.1.

The system falls within a protection scope of this solution when concurrently meeting the following conditions: the number N of the chunks is equal to a number S of devices of the pipeline, and the S^{th} device employs the 1F1B scheduling when processing the N-th chunk.

Any solution circumventing infringement by making N≠S will lead to at least one of the following defects:
the utilization of the devices is decreased by 15% or more;
the peak video memory usage is increased by 30% or more; and
a maximum trainable scale of the model is reduced by over 40%.

These defects are attributable to the condition of N S in the traditional solution, which results in over 28% idle waiting time. By contrast, implementing this solution achieves 100% utilization of the devices (experimental measurements demonstrate that training efficiency for ResNet-152 is increased by 35%).

In some embodiments, in a process of performing calculations on the N-th chunk, a cumulative number of micro-batches with unreleased activation values does not exceed (S−s+1), wherein S represents a total number of pipeline stages, and s represents a stage index of a device currently in performance (1≤s≤S).

In embodiments of the present disclosure, the number of the micro-batches with the unreleased activation values is a number of the micro-batches in the pipeline that have completed the forward calculation but have not yet started the backward calculation. Illustratively, when 3 micro-batches are waiting for the backward calculation, the number of the micro-batches with the unreleased activation values is 3.

In embodiments of the present disclosure, the total number S of the pipeline stages is a total number of the stages (that is, the number of the physical devices) into which the model is divided. Illustratively, during training on an 8-GPU set, S is equal to 8.

In embodiments of the present disclosure, the stage index s is a logical number of a device currently in performance (1≤s≤S), with s=1 corresponding to an input layer and s=S corresponding to an output layer. Exemplarily, if the device 3 is responsible for the stage 3, s is equal to 3.

In embodiments of the present disclosure, a constraint formula (S−s+1) represents an upper limit on a number of micro-batches with activation values allowed to be backlogged on any device. Illustratively, when S=8 and s=3, the upper limit is equal to 8−3+1=6.

In embodiments of the present disclosure, device s=1 (input): can backlog S activation values (need to wait for all downstream devices); and device s=S (output): is only allowed to backlog 1 activation value (must be reversely released immediately). A dynamic balancing mechanism: ensures that the occupancy of the video memory exhibits an inverted pyramid distribution, preventing a device at a tail end from becoming a bottleneck.

Taking a pipeline with S=4 as an example, implementation steps include:
step 1, initializing a constraint engine:
a backlog upper limit of the current device s is calculated in real time, for example, during operation on a device s=2, the upper limit is equal to 4−2+1=3;
step 2, performing real-time monitoring and scheduling (from a perspective of the device s=2), as particularly shown in Table 4:

TABLE 4

| | | | Complies with | |
|---|---|---|---|---|
| Time | Event | Backlog Count | Constraints? | Action |
| t1 | complete forward | 1→2 | 2 ≤ 3 (compliant) | defer backward |
| | calculation for | | | calculation |
| | micro-batch 5 | | | |
| t2 | complete forward | 2→3 | 3 ≤ 3 (compliant) | defer backward |
| | calculation for | | | calculation |
| | micro-batch 6 | | | |
| t3 | complete forward | 3→4 | 4 > 3 (violation) | immediately |
| | calculation for | | | trigger backward |
| | micro-batch 7 | | | calculation for |
| | | | | earliest micro- |
| | | | | batch 5 |
| t4 | complete backward | 4→3 | compliant | release video |
| | calculation for | | | memory and |
| | micro-batch 5 | | | continue forward |
| | | | | calculation |

step 3, forming a border protection mechanism:
when it is detected that a backlog count is equal to (S−s+1)−1, a new forward calculation is automatically suspended, and
a backward calculation priority scheduling strategy: employs a first in first out (FIFO) discipline to release the earliest backlogged micro-batches.

As such, in the traditional solution, the device (s=S) at the tail end backlogs K activation values (typically, K≥16). In contrast, in this solution, the device (s=S) at the tail end backlogs at most 1 activation value (because S−S+1=1), and the device at the input (s=1) backlogs at most S activation values. Therefore, the peak video memory usage is reduced to an order of 1/K of that in the traditional solution (experimental measurements demonstrate that when S=8 and K=32, reduced by 87.5%). Through dynamic constraints, this solution immediately initiates backward calculation when the number of the micro-batches reaches (S−s), thereby constructing a negative feedback system via formulaic constraints, which avoids the risk of manual parameter adjustment and improving the stability of the system. During training on a thousand-GPU cluster (S=1024), the traditional solution suffers from a training interruption rate of 15% or more due to memory overflow on the device at the tail end. In contrast, this solution achieves 100% training stability, increases the cluster availability to 99.95%, and reduces the cost per training task.

In some embodiments, the pipeline parallel architecture includes S computing devices communicatively coupled, and each computing device corresponds to a stage of a deep learning model.

In embodiments of the present disclosure, communication coupling enables millisecond-level data exchange between devices through a high-speed interconnect architecture.

In embodiments of the present disclosure, stages refer to computing units into which the model is divided by layers. Each stage is executed sequentially and is data dependent. Exemplarily, the BERT model is divided as follows: stage1—word embedding, stage2—transformer layers 1-6, stage3—transformer layers 7-12, and stage4—output layer.

In embodiments of the present disclosure, there are S devices communication coupled, with each computing device corresponding to one model stage. In embodiments of the present disclosure, physical-logical mapping refers to a scenario where a single physical device can accommodate a plurality of logical stages (vertical division). Illustratively, a certain GPU runs 2 adjacent transformer layer stages.

In some embodiments, devices in adjacent stages can communicate via a point-to-point direct connection.

In some implementations, devices in non-adjacent stages communicate via a remote direct memory access (RDMA) network.

In some implementations, a single physical device accommodates a plurality of consecutive logical stages.

In an S-stage pipeline, a theoretical minimum delay of this communication architecture is defined as:

T_min=E_{i=1}\hat{ }{S−1}[L_adj(i)+L_nonadj(i)], wherein L_adj represents a latency between adjacent stages and L_nonadj represents a latency between non-adjacent stages.

As such, the communication efficiency is improved to reduce the communication latency between adjacent stages, and the bandwidth between the non-adjacent stages is increased to shorten the training task completion time is shortened.

In some embodiments, the computing device is a graphics processing unit (GPU) or a tensor processing unit (TPU).

In embodiments of the present disclosure, the GPU is a hardware dedicated to parallel computing and has thousands of computing cores and a high-bandwidth video memory.

In embodiments of the present disclosure, the TPU is an application specific integrated circuit (ASIC) chip optimized for matrix operations, integrating a systolic array and a high-speed on-chip memory.

In some implementations, the GPU enables a tensor core to perform mixed-precision calculations. The TPU accelerates the matrix operations through a systolic array hardware, and employs a device-specific communication library for distributed gradient aggregation.

In some implementations, hardware resources are pre-configured and computing cores are customized. Operation types include but are not limited to matrix multiplication, gradient aggregation, activation functions, and the like. By combining specific task requirements and data characteristics, configuring hardware resources and customizing the computing core, the performance and efficiency of the model can be effectively improved.

As such, an order-of-magnitude improvement in computing efficiency can be achieved and the robustness of the system can be enhanced.

In practical applications, a large language model can be deployed on a computing device. Based on training samples, the large language model deployed on the computing device is trained to obtain a target model.

Among them, in a process of training the large language model deployed on the computing device, the following process is performed: dividing training data into N consecutive chunks, wherein each chunk includes K micro-batches, wherein N≥2, K≥2 and both N and K are integers;
performing calculations on first N−1 chunks by using an interleaved forward-then-backward scheduling strategy; and
performing calculations on an N-th chunk by using an interleaved 1F1B scheduling strategy,
wherein the performing calculations on an N-th chunk by using an interleaved 1F1B scheduling strategy includes: for any micro-batch in the N-th chunk, triggering a backward calculation immediately upon completion its forward calculation; and for any micro-batch, releasing a video memory occupied by an activation value generated during its forward calculation immediately upon completion its backward calculation.

In embodiments of the present disclosure, the computing device may be a server device or a terminal device.

In embodiments of the present disclosure, the target model may be a natural language processing model configured to perform at least one of information extraction, text classification, text recognition, speech recognition and question answering on a first type of to-be-processed data to obtain a natural language processing result. The target model may be a computer vision processing model configured to perform at least one of image recognition, target detection, semantic segmentation, video understanding and image generation on a second type of to-be-processed data to obtain a computer vision processing result. The foregoing is merely illustrative, and is not intended to limit all possible types of target models, as an exhaustive listing is not provided herein.

It should be understood that schematic diagrams shown in FIG. 1 and FIG. 2 are merely illustrative and not restrictive, and are extensible. Those skilled in the art can make various obvious modifications and/or substitutions based on examples of FIG. 1 and FIG. 2, and resulting technical solutions still fall within the scope of embodiments of the present disclosure.

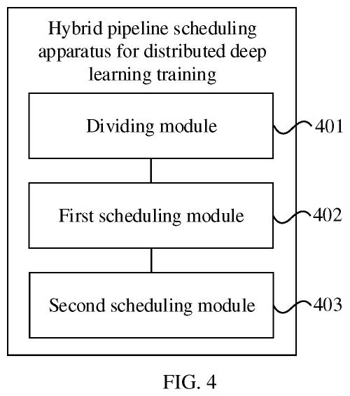

An embodiment of the present disclosure provides a hybrid pipeline scheduling apparatus for distributed deep learning training, which is applied in a pipeline parallel architecture including a plurality of computing devices. As shown in FIG. 4, the hybrid pipeline scheduling apparatus for distributed deep learning training may include:
a dividing module 401 configured to divide training data into N consecutive chunks, wherein each chunk includes K micro-batches, wherein N≥2, K≥2 and both N and K are integers;
a first scheduling module 402 configured to perform calculations on first N−1 chunks by using an interleaved forward-then-backward scheduling strategy; and
a second scheduling module 403 configured to perform calculations on an N-th chunk by using an interleaved 1F1B scheduling strategy.

In some embodiments, the second scheduling module 403 includes a first control submodule configured to: for any micro-batch in the N-th chunk, trigger a backward calculation immediately upon completion of its forward calculation; and a second control submodule configured to: for any micro-batch, release a video memory occupied by an activation value generated during its forward calculation immediately upon completion of its backward calculation.

In some embodiments, the interleaved 1F1B scheduling strategy enables a peak video memory usage to occur at a moment when the forward calculation for a first micro-batch of the N-th chunk is completed.

In some embodiments, a number N of the chunks is equal to a pipeline depth.

In some embodiments, in a process of performing calculations on the N-th chunk, a cumulative number of micro-batches with unreleased activation values does not exceed (S−s+1), wherein S represents a total number of pipeline stages, and s represents a stage index of a device currently in performance (1≤s≤S).

In some embodiments, the pipeline parallel architecture includes S computing devices communicatively coupled, and each computing device corresponds to a stage of a deep learning model.

In some embodiments, the computing device is a GPU or TPU.

Those skilled in the art should understand that functions of each processing module in the hybrid pipeline scheduling apparatus for distributed deep learning training in embodiments of the present disclosure can be understood with reference to the related description of the aforementioned hybrid pipeline scheduling method for distributed deep learning training. Each processing module in the hybrid pipeline scheduling apparatus for distributed deep learning training in embodiments of the present disclosure can be implemented by a generation circuit implementing the functions of embodiments of the present disclosure or by running software on an electronic device performing the functions of embodiments of the present disclosure.

The hybrid pipeline scheduling apparatus for distributed deep learning training in embodiments of the present disclosure can reduce the peak video memory usage during parallel training of a deep learning model pipeline, thereby significantly reducing the video memory requirement during large model training, improving the training efficiency, and indirectly improving the performance of large model training.

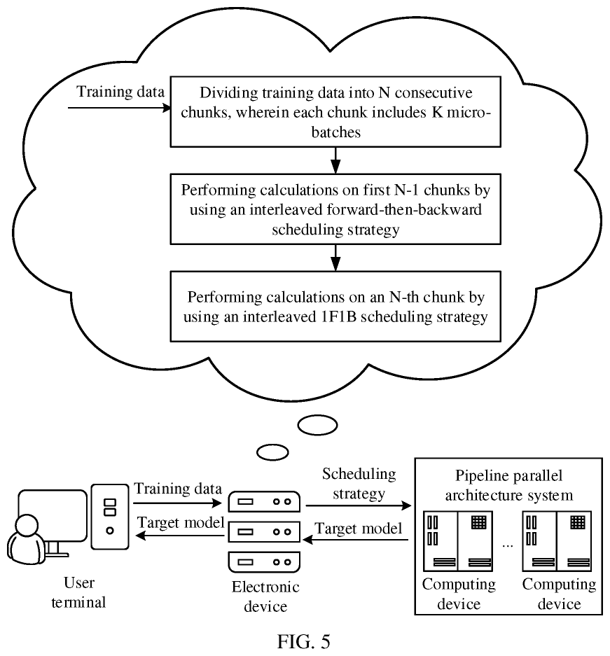

An embodiment of the present disclosure provides a schematic diagram of a scenario of a hybrid pipeline scheduling method for distributed deep learning training according to an embodiment of the present disclosure, as shown in FIG. 5.

As described previously, the hybrid pipeline scheduling method for distributed deep learning training provided by embodiments of the present disclosure is applied to an electronic device. The electronic device is intended to represent various forms of digital computers, such as a laptop computer, a desktop computer, a workstation, a personal digital assistant, a server, a blade server, a mainframe computer and further appropriate computers. The electronic device may represent various forms of mobile apparatuses, such as a personal digital assistant, a cellular phone, a smart phone, a wearable device and further similar computing apparatuses.

Particularly, the electronic device can particularly perform the following operations:
dividing training data into N consecutive chunks, wherein each chunk includes K micro-batches, wherein N≥2, K≥2 and both N and K are integers;
performing calculations on first N−1 chunks by using an interleaved forward-then-backward scheduling strategy; and
performing calculations on an N-th chunk by using an interleaved 1F1B scheduling strategy,
wherein the performing calculations on an N-th chunk by using an interleaved 1F1B scheduling strategy includes: for any micro-batch in the N-th chunk, triggering a backward calculation immediately upon completion of its forward calculation; and for any micro-batch, releasing a video memory occupied by an activation value generated during its forward calculation immediately upon completion of its backward calculation.

It should be understood that the diagram of the scenario shown in FIG. 5 is only illustrative and not restrictive. Those skilled in the art can make various obvious modifications and/or substitutions based on examples of FIG. 5, and resulting technical solutions still fall within the scope of embodiments of the present disclosure.

In the technical solution of the present disclosure, acquisition, storage, application and the like of involved user personal information comply with relevant laws and regulations, and do not violate public order and good morals.

According to embodiments of the present disclosure, the present disclosure further provides an electronic device, a readable storage medium and a computer program product.

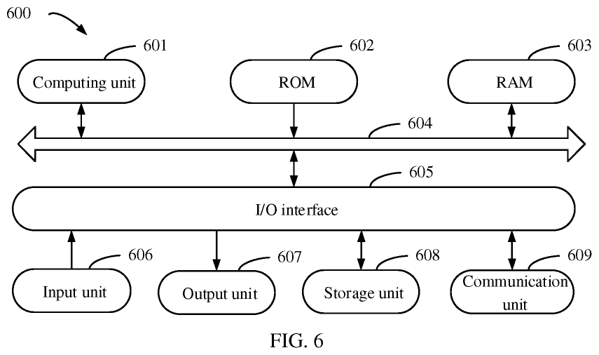

FIG. 6 shows a schematic block diagram of an example electronic device 600 which may be configured to implement embodiments of the present disclosure. The electronic device is intended to represent various forms of digital computers, such as a laptop computer, a desktop computer, a workstation, a personal digital assistant, a server, a blade server, a mainframe computer and further appropriate computers. The electronic device may represent various forms of mobile apparatuses, such as a personal digital assistant, a cellular phone, a smart phone, a wearable device and further similar computing apparatuses. Components shown herein, their connections and relationships and their functions are merely examples, and are not intended to limit implementations of the present disclosure described and/or claimed herein.

As shown in FIG. 6, the device 600 includes a computing unit 601 which may perform various appropriate actions processes according to a computer program stored in a read only memory (ROM) 602 or a computer program loaded from a storage unit 608 into a random-access memory (RAM) 603. Various programs and data required for the operation of the electronic device 600 may be also stored in the RAM 603. The computing unit 601, the ROM 602 and the RAM 603 are connected with each other through a bus 604. An input/output (I/O) interface 605 is also connected to the bus 604.

A plurality of components in the device 600 are connected to the I/O interface 605, and include an input unit 606, such as a keyboard, a mouse, and the like; an output unit 607, such as various types of displays, speakers, and the like; a storage unit 608, such as a magnetic disk, an optical disk, and the like; and a communication unit 609, such as a network card, a modem, a wireless communication transceiver, and the like. The communication unit 609 allows the device 600 to exchange information/data with further devices through a computer network such as Internet, and/or various telecommunication networks.

The computing unit 601 may be a variety of general and/or dedicated purpose processing components with processing and computing capabilities. Some examples of the computing unit 601 include but are not limited to a central processing unit (CPU), a graphic processing unit (GPU), various dedicated artificial intelligence (AI) computing chips, various computing units running a machine learning model algorithm, a digital signal processor (DSP), and any appropriate processor, controller, microcontroller, and the like. The computing unit 601 performs various methods and processes described above, such as the hybrid pipeline scheduling method for distributed deep learning training. For example, in some embodiments, the hybrid pipeline scheduling method for distributed deep learning training may be implemented as a computer software program tangibly included in a machine-readable medium, such as the storage unit 608.

In some embodiments, a part or all of the computer program may be loaded and/or installed into the device 600 via the ROM 602 and/or the communication unit 609. The computer program, when being loaded into the RAM 603 and executed by the computing unit 601, performs one or more steps of the hybrid pipeline scheduling method for distributed deep learning training described above. Alternatively, in further embodiments, the computing unit 601 may be configured to perform the hybrid pipeline scheduling method for distributed deep learning training in any other appropriate means (for example, by means of a firmware).

Various implementations of systems and technologies described herein may be practiced in a digital electronic circuitry, an integrated circuitry, a field programmable gate array (FPGA), a dedicated application specific integrated circuit (ASIC), an application specific standard product (ASSP), a system on a chip (SOC), a complex programmable logic device (CPLD), a computer hardware, a firmware, a software, and/or a combination thereof. These implementations may include an implementation in one or more computer programs executable and/or interpretable on a programmable system including at least one programmable processor which may be a dedicated or general purpose programmable processor, may receive data and instructions from a storage system, at least one input apparatus and at least one output apparatus, and transmit the data and the instructions to the storage system, the at least one input apparatus and the at least one output apparatus.

Program codes for implementing the method of the present disclosure may be written in any combination of one or more programming languages. These program codes may be provided to a processor or a controller of a general-purpose computer, a dedicated purpose computer or further programmable data processing apparatuses, such that the program codes, when being executed by the processor or the controller, cause functions/operations specified in the flowchart and/or the block diagram to be implemented. The program codes may be executed entirely on a machine, executed partly on a machine, executed partly on a machine as a stand-alone software package and executed partly on a remote machine, or executed entirely on a remote machine or a server.

In the context of the present disclosure, the machine-readable medium may be a tangible medium which may contain or store a program for use by or in conjunction with an instruction execution system, apparatus or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

To provide interaction with a user, the systems and technologies described here may be implemented on a computer that has a display apparatus (for example, a cathode ray tube (CRT) or a liquid crystal display (LCD) monitor) for displaying information to the user; and a keyboard and a pointing apparatus (for example, a mouse or a trackball) through which the user can provide input to the computer. Other types of apparatuses may further be used to provide interaction with the user. For example, feedback provided to the user can be any form of sensory feedback (for example, visual feedback, auditory feedback or tactile feedback); and input from the user may be received in any form (including acoustic input, speech input or tactile input).

Systems and technologies described here may be implemented in a computing system (for example, as a data server) which includes a back-end component, or a computing system (for example, as an application server) which includes a middleware component, or a computing system (for example, as a user computer with a graphical user interface or a web browser through which the user may interact with implementations of the systems and the technologies described herein) which includes a front-end component, or a computing system which includes any combination of the back-end component, the middleware component or the front-end component.

The components of the system may be interconnected via digital data communication in any form or medium (for example, a communication network). Examples of the communication network include a local area network (LAN), a wide area network (WAN) and the Internet.

A computer system may include a client and a server. Generally, the client and the server are far away from each other and typically interact via the communication network. The relationship between the client and the server is generated by virtue of computer programs running on respective computers and having a client-server relationship with each other. The server may be a cloud server, or a server of a distributed system, or a server incorporating a blockchain.

It should be understood that various forms of processes shown above may be used to reorder, add or delete steps. For example, steps described in the present disclosure may be executed in parallel, sequentially, or in different orders provided that desired results of the technical solution disclosed in the present disclosure may be achieved, which is not limited here.

The foregoing specific implementations do not constitute a limitation on the protection scope of the present disclosure. Those skilled in the art should understand that various modifications, combinations, sub-combinations and substitutions can be made according to design requirements and further factors. Any modifications, equivalent substitutions and improvements made within the spirit and principle of the present disclosure shall be included in the protection scope of the present disclosure.

What is claimed is:

1. A hybrid pipeline scheduling method for distributed deep learning training, applied in a pipeline parallel architecture comprising a plurality of computing devices, wherein the method comprises:
dividing training data into N consecutive chunks, wherein each chunk includes K micro-batches, wherein N≥2, K≥2 and both N and K are integers;
performing calculations on first N−1 chunks by using an interleaved forward-then-backward scheduling strategy; and
performing calculations on an N-th chunk by using an interleaved 1F1B scheduling strategy,
wherein the performing calculations on the N-th chunk by using an interleaved 1F1B scheduling strategy comprises: for any micro-batch in the N-th chunk, triggering a backward calculation immediately upon completion of its forward calculation; and for any micro-batch, releasing a video memory occupied by an activation value generated during its forward calculation immediately upon completion of its the backward calculation.

2. The method of claim 1, wherein the interleaved 1F1B scheduling strategy enables a peak video memory usage to occur at a moment when the forward calculation of a first micro-batch of the N-th chunk is completed.

3. The method of claim 1, wherein a number N of the chunks is equal to a pipeline parallel depth.

4. The method of claim 1, wherein in a process of executing the N-th chunk, a cumulative number of micro-batches with unreleased activation values does not exceed (S−s+1), wherein S represents a total number of pipeline stages, and s represents a stage index of a device currently in performance, wherein 1≤s≤S.

5. The method of claim 1, wherein the pipeline parallel architecture comprises S computing devices communicatively coupled, and each computing device corresponds to a stage of a deep learning model.

6. The method of claim 1, wherein the computing device is a graphics processor or a tensor processor.

7. An electronic device, applied in a pipeline parallel architecture comprising a plurality of computing devices, comprising:
at least one processor; and
a memory communicatively connected to the at least one processor, wherein
the memory stores an instruction executable by the at least one processor, and the instruction is executed by the at least one processor to cause the at least one processor to perform:
dividing training data into N consecutive chunks, wherein each chunk includes K micro-batches, wherein N≥2, K≥2 and both N and K are integers;
performing calculations on first N−1 chunks by using an interleaved forward-then-backward scheduling strategy; and
performing calculations on an N-th chunk by using an interleaved 1F1B scheduling strategy,
wherein the performing calculations on the N-th chunk by using the interleaved 1F1B scheduling strategy comprises: for any micro-batch in the N-th chunk, triggering a backward calculation immediately upon completion of its forward calculation; and for any micro-batch, releasing a video memory occupied by an activation value generated during its forward calculation immediately upon completion of its the backward calculation.

8. The electronic device of claim 7, wherein the interleaved 1F1B scheduling strategy enables a peak video memory usage to occur at a moment when the forward calculation of a first micro-batch of the N-th chunk is completed.

9. The electronic device of claim 7, wherein a number N of the chunks is equal to a pipeline parallel depth.

10. The electronic device of claim 7, wherein in a process of executing the N-th chunk, a cumulative number of micro-batches with unreleased activation values does not exceed (S−s+1), wherein S represents a total number of pipeline stages, and s represents a stage index of a device currently in performance, wherein 1≤s≤S.

11. The electronic device of claim 7, wherein the pipeline parallel architecture comprises S computing devices communicatively coupled, and each computing device corresponds to a stage of a deep learning model.

12. The electronic device of claim 7, wherein the computing device is a graphics processor or a tensor processor.

13. A non-transitory computer-readable storage medium storing a computer instruction, applied in a pipeline parallel architecture comprising a plurality of computing devices, wherein the computer instruction is used to cause a computer to perform:
dividing training data into N consecutive chunks, wherein each chunk includes K micro-batches, wherein N≥2, K≥2 and both N and K are integers;
performing calculations on first N−1 chunks by using an interleaved forward-then-backward scheduling strategy; and
performing calculations on an N-th chunk by using an interleaved 1F1B scheduling strategy,
wherein the performing calculations on the N-th chunk by using the interleaved 1F1B scheduling strategy comprises: for any micro-batch in the N-th chunk, triggering a backward calculation immediately upon completion of its forward calculation; and for any micro-batch, releasing a video memory occupied by an activation value generated during its forward calculation immediately upon completion of its the backward calculation.

14. The non-transitory computer-readable storage medium of claim 13, wherein the interleaved 1F1B scheduling strategy enables a peak video memory usage to occur at a moment when the forward calculation of a first micro-batch of the N-th chunk is completed.

15. The non-transitory computer-readable storage medium of claim 13, wherein a number N of the chunks is equal to a pipeline parallel depth.

16. The non-transitory computer-readable storage medium of claim 13, wherein in a process of executing the N-th chunk, a cumulative number of micro-batches with unreleased activation values does not exceed (S−s+1), wherein S represents a total number of pipeline stages, and s represents a stage index of a device currently in performance, wherein 1≤s≤S.

17. The non-transitory computer-readable storage medium of claim 13, wherein the pipeline parallel architecture comprises S computing devices communicatively coupled, and each computing device corresponds to a stage of a deep learning model.

18. The non-transitory computer-readable storage medium of claim 13, wherein the computing device is a graphics processor or a tensor processor.
